(19) United States
(12) Patent Application Publication
(10) Pub. No.: US 2015/0022493 A1
(43) Pub. Date: Jan. 22, 2015

(54) TOUCH PEN

(71) Applicant: Wintek Corporation, Taichung City (TW)

(72) Inventors: Shyh-Jeng CHEN, Tai Chung County (TW); Chong-Wei LI, Chang Hau City (TW); Wen-Hsin WANG, Chang Hua City (TW); Tsung-Yu WANG, Tai Chung City (TW); Chih-Chiang LIN, Tai Chung City (TW)

(21) Appl. No.: 14/333,404

(22) Filed: Jul. 16, 2014

(30) Foreign Application Priority Data
Jul. 19, 2013 (TW) 102125946

(51) Int. Cl. G06F 3/044; G06F 3/0354

(52) U.S. Cl. CPC G06F 3/044; G06F 3/03545
USPC 345/174; 345/179

(57) ABSTRACT

A touch pen includes a power supply circuit, a signal-receiving electrode, a noise-sensing electrode, an inverted amplifying circuit, and a signal-emitting electrode. The power supply circuit provides the touch pen with a working voltage, the signal-receiving electrode receiving at least one surface signal of a touch-sensing electrode structure of a capacitive touch-sensitive device, and the noise-sensing electrode receives at least one ambient noise signal. The inverted amplifying circuit reversely amplifies a difference between the surface signal and the ambient noise signal to generate a reversely amplified signal, and the signal-emitting electrode emits the reversely amplified signal to attenuate a detection signal of the capacitive touch-sensitive device in a position coinciding with a touch point of the touch pen.

### BACKGROUND OF THE INVENTION

a. Field of the Invention

The invention relates to a touch pen in general and more specifically to a touch pen for a capacitive touch-sensitive device.

b. Description of the Related Art

FIG. 1A and FIG. 1B show schematic diagrams illustrating conventional operations of sensing touch points of a user's finger on a capacitive touch-sensitive device 100. Referring to FIG. 1A and FIG. 1B, each Y-axis electrode 102, for example, may emit a voltage pulse to detect induced charge on each X-axis electrode 104. Therefore, compared with a pulse signal transmitted to a non-touch position, finger capacitance is formed, as a result of a human body being grounded, in a touch position to weaken a pulse signal transmitted to an X-axis electrode 104. Accordingly, the X-axis electrodes 104 that are currently touched by fingers 106 are detected to figure out touch position coordinates of the fingers 106. Further, since the voltage pulse is successively applied to a group of Y-axis electrodes, two or more points of contact made with a surface of the capacitive touch-sensitive device 100 at a time can be also accurately recognized.

As shown in FIG. 2, a conventional touch pen 200 includes a signal-receiving electrode 202, a signal-emitting electrode 204, a conductive separation layer 206, a power supply circuit 208, and an inverted amplifying circuit 210. The power supply circuit 208 provides the touch pen 200 with a working voltage. The signal-receiving electrode 202 receives, such as by induction, at least one surface signal of a touch-sensing electrode structure (not shown). Typically, a conductive separation layer 206 may be interposed between the signal-receiving electrode 202 and the signal-emitting electrode 204 to avoid signal interference. However, as shown in FIG. 3, undesired parasitic capacitances 212 may be formed between the conductive separation layer 206 and the signal-receiving electrode 202 and between the conductive separation layer 206 and the signal-emitting electrode 204 to result in signal distortion.

### BRIEF SUMMARY OF THE INVENTION

The invention provides a touch pen for a capacitive touch-sensitive device.

Other objects and advantages of the invention can be better understood from the technical characteristics disclosed by the invention. In order to achieve one of the above purposes, all the purposes, or other purposes, one embodiment of the invention provides a touch pen including a power supply circuit, a signal-receiving electrode, a noise-sensing electrode, an inverted amplifying circuit, and a signal-emitting electrode. The power supply circuit provides the touch pen with a working voltage, the signal-receiving electrode receiving at least one surface signal of a touch-sensing electrode structure of a capacitive touch-sensitive device, and the noise-sensing electrode receives at least one ambient noise signal. The inverted amplifying circuit reversely amplifies a difference between the surface signal and the ambient noise signal to generate a reversely amplified signal, and the signal-emitting electrode emits the reversely amplified signal to attenuate a detection signal of the capacitive touch-sensitive device in a position coinciding with a touch point of the touch pen.

In one embodiment, a magnification of the inverted amplifying circuit is 50-500.

In one embodiment, an insulation member is disposed between the signal-emitting electrode and the signal-receiving electrode and between the signal-emitting electrode and the noise-sensing electrode to insulate the signal-receiving electrode, the signal-emitting electrode and the noise-sensing electrode from one another.

In one embodiment, the insulation member may be in the shape of a cylinder, the signal-receiving electrode may be a metal ring or a coil of metal, and the noise-sensing electrode is a metal ring or a coil of metal.

In one embodiment, the signal-emitting electrode may include an antenna structure and an electrode wire, and a conductive rubber may surround the antenna structure. The conductive rubber may have at least one round corner.

In one embodiment, the touch-sensing electrode structure includes a plurality of first sensing series and a plurality of second sensing series, the first sensing series receive at least one scan signal, and the second sensing series receive the detection signal.

In one embodiment, the inverted amplifying circuit may include an operational amplifier. The inverted amplifying circuit has positive input, a negative input and an output, the positive input is connected to the noise-sensing electrode, the negative input is connected to the signal-receiving electrode, and the output is connected to the signal-emitting electrode. An output value of the inverted amplifying circuit is obtained by subtracting an input value of the negative input from an input value of the positive input and then multiplying a gain of the operational amplifier.

According to the above embodiments, only a tiny amount of power lines is needed to generate a surface signal, and the surface signal is reversely amplified to attenuate a detection signal of the capacitive touch-sensitive device to detect touch positions. Therefore, a pen head of the touch pen is allowed to be minimized to perform accurate touch operations on the capacitive touch-sensitive device. Further, since the noise-sensing electrode is provided for sensing ambient noises, the inverted amplifying circuit may perform back-end differential signal processing to filter out ambient noises. Therefore, a separation conductive layer or a separation electrode may be omitted from a touch pen to save costs and reduce parasitic capacitances formed as a result of the separation conductive layer or the separation electrode.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1A and FIG. 1B show schematic diagrams illustrating conventional operations of sensing touch points of a user's finger on a capacitive touch-sensitive device.

FIG. 2 shows a schematic diagram illustrating a conventional touch pen for a capacitive touch-sensitive device

FIG. 3 shows a schematic diagram illustrating parasitic capacitances formed as a result of a separation conductive layer.

FIG. 4 shows a touch pen for a capacitive touch-sensitive device according to an embodiment of the invention.

FIG. 5 shows a block diagram illustrating operations of the touch pen shown in FIG. 4.

FIG. 6 shows a circuit diagram illustrating an inverted amplifying circuit according to an embodiment of the invention.

FIG. 7 shows a schematic diagram illustrating a touch pen for a capacitive touch-sensitive device according to another embodiment of the invention.

FIG. 8 shows a schematic diagram illustrating a touch pen for a capacitive touch-sensitive device according to another embodiment of the invention.

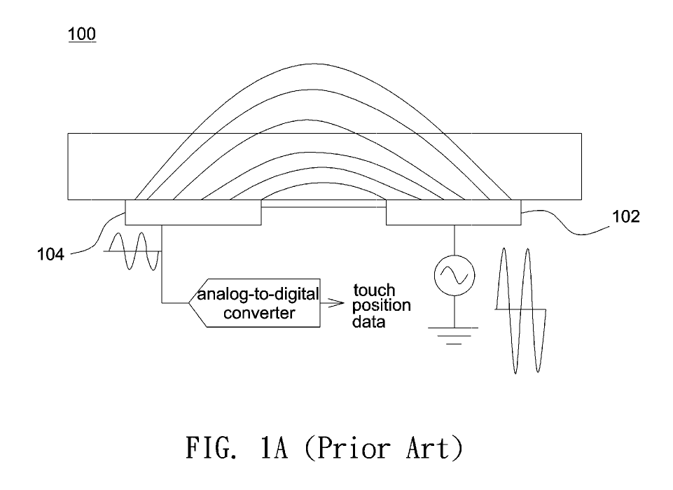

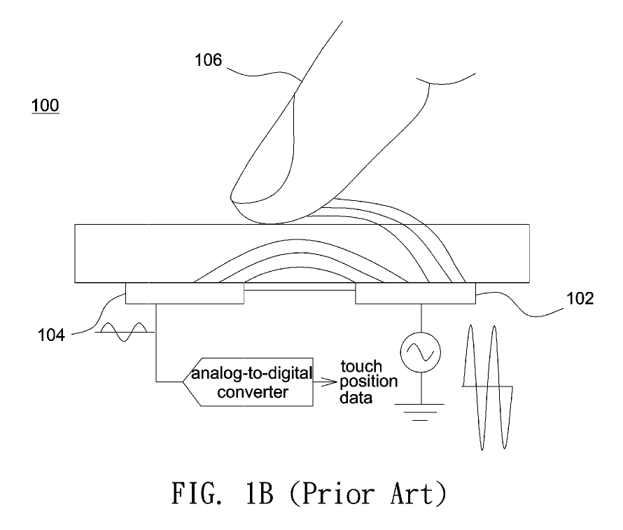

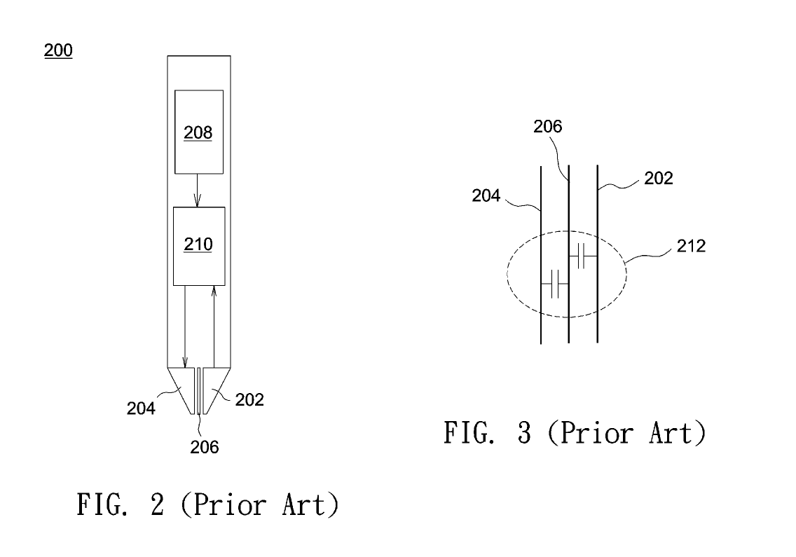

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

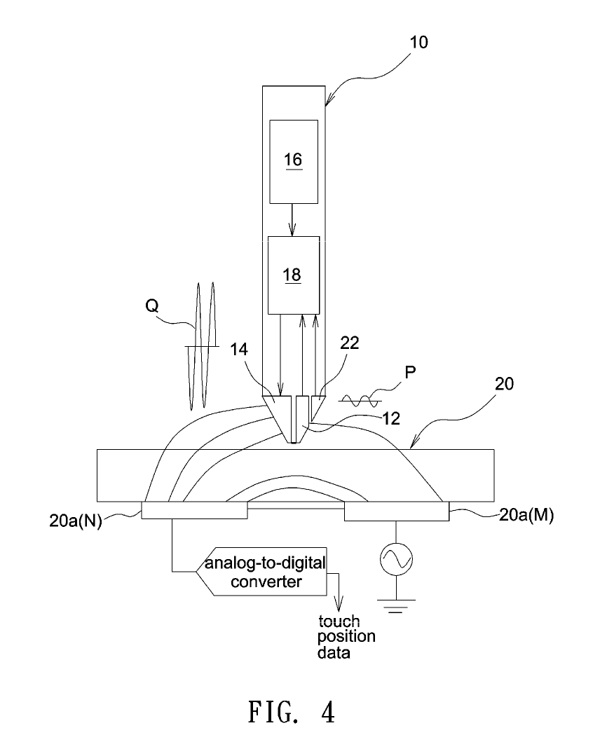

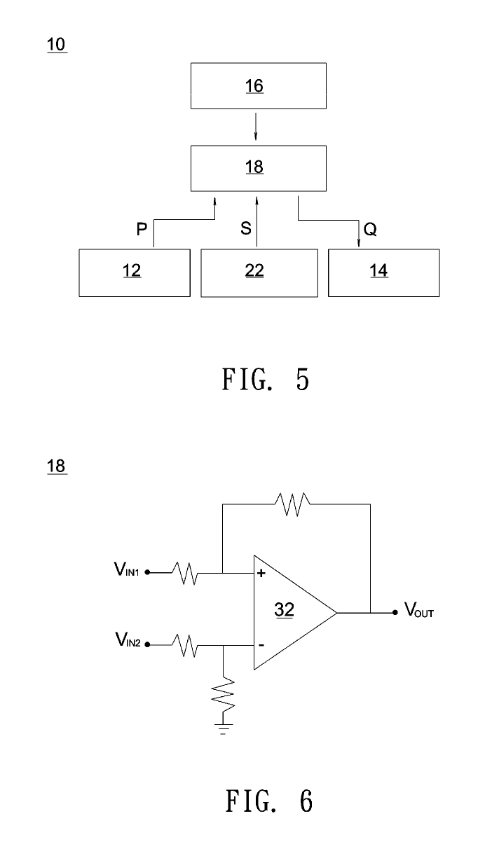

FIG. 4 shows a touch pen for a capacitive touch-sensitive device according to an embodiment of the invention. FIG. 5 shows a block diagram illustrating operations of the touch pen shown in FIG. 4. Please refer to both FIG. 4 and FIG. 5, a touch pen 10 includes a signal-receiving electrode 12, a signal-emitting electrode 14, a power supply circuit 16, an inverted amplifying circuit 18, and a noise-sensing electrode 22. The power supply circuit 16 provides the touch pen 10 with a working voltage. The signal-receiving electrode 12 receives, such as by induction, at least one surface signal P of a touch-sensing electrode structure 20a of a capacitive touch-sensitive device 20. The touch-sensing electrode structure 20a may include multiple first sensing series M and multiple second sensing series N. In one embodiment, the first sensing series M receive at least one scan signal and are successively driven by the scan signal to scan the entire touch-sensing electrode structure 20a. The second sensing series N receive at least one detection signal to sense capacitive coupling formed as a result of a touch action when the scan signal successively drives the first sensing series M. In one embodiment, the surface signal P is induced by the power lines between the touch-sensing electrode structure 20a (M) and the signal-receiving electrode 12, and the detection signal is induced by the power lines between the touch-sensing electrode structure 20a(N) and the signal-emitting electrode 14. The noise-sensing electrode 22 may receive at least one ambient noise signal S. The inverted amplifying circuit 18 reversely amplifies a filtered surface signal P to generate a reversely amplified signal Q, and the signal-emitting electrode 14 emits the reversely amplified signal Q. The reversely amplified signal Q may attenuate a detection signal in a position coinciding with a touch point of the touch pen 10, and therefore the detection signal in the touch point is weaken compared with other detection signals in non-touch positions to recognize current touch positions of the touch pen 10.

FIG. 6 shows a circuit diagram of the inverted amplifying circuit 18 according to an embodiment of the invention. The noise filtering and reversely amplifying operations according to an embodiment of the invention are described below with reference to FIG. 6. The inverted amplifying circuit 18 is not limited to a specific structure, as long as the effect of reversely amplifying a filtered surface signal P is achieved. For example, an operational amplifier 32 that has linear gain control may function as an inverted amplifying circuit, where the output of the operational amplifier 32 is controlled by its input. In this embodiment, a positive input V_{IN1} of the inverted amplifying circuit 18 is connected to the noise-sensing electrode 22, a negative input V_{IN2} of the inverted amplifying circuit 18 is connected to the signal-receiving electrode 12, and an output V_{OUT} is connected to the signal-emitting electrode 14. Therefore, an ambient noise signal S and a capacitive coupling signal are fed to the positive input V_{IN1}, and a surface signal P (composed of a touch-sensing signal and an ambient noise signal S) and a capacitive coupling signal are fed to the negative input V_{IN2}. Therefore, an output value of the inverted amplifying circuit 18 is obtained by subtracting an input value of the negative input V_{IN2} from an input value of the positive input V_{IN1} and then multiplying a gain of the operational amplifier 32. Accordingly, since the output value of the inverted amplifying circuit 18 is obtained by the operations of noise deduction and reverse amplification, the inverted amplifying circuit 18 may output a reversely amplified signal Q, with ambient noises being filtered out, through the output V_{OUT}.

According to the above embodiments, only a tiny amount of power lines is needed to generate a surface signal P, and the surface signal P is reversely amplified to attenuate a detection signal of the capacitive touch-sensitive device 20 to detect touch positions. Therefore, a pen head of the touch pen 10 is allowed to be minimized to perform accurate touch operations on the capacitive touch-sensitive device 20. Further, since the noise-sensing electrode 22 is provided for sensing ambient noises, the inverted amplifying circuit 18 may perform back-end differential signal processing to filter out ambient noises. Therefore, a separation conductive layer or a separation electrode may be omitted from a touch pen 10 to save costs and reduce parasitic capacitances formed as a result of the separation conductive layer or the separation electrode.

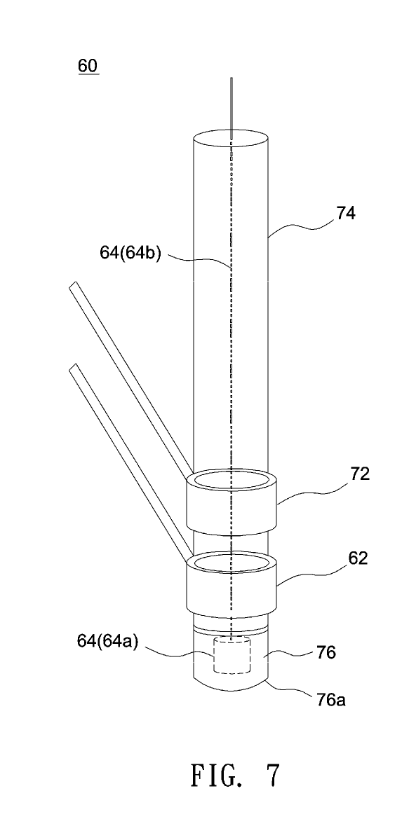

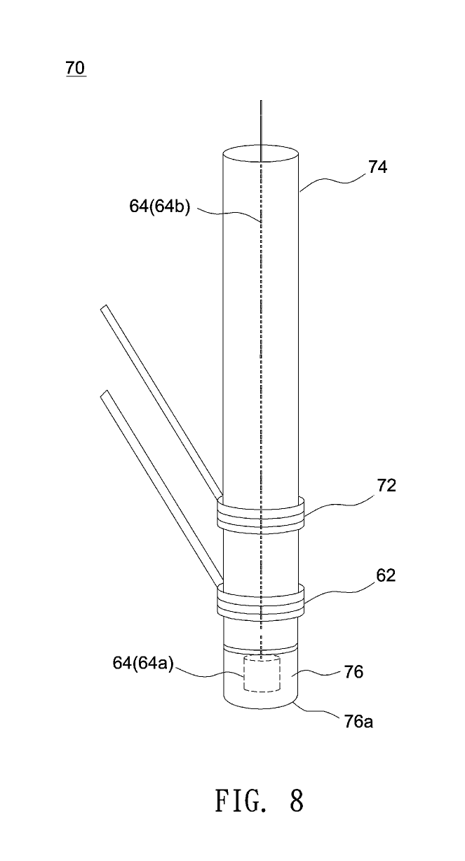

FIG. 7 shows a schematic diagram of a touch pen for a capacitive touch-sensitive device according to another embodiment of the invention. Referring to FIG. 7, a signal-receiving electrode 62 and a noise-sensing electrode 72 may be two metal rings spaced apart from each other, and a signal-emitting electrode 64 may include an antenna structure 64a and an electrode wire 64b. An insulation member 74 is interposed between the signal-emitting electrode 64 and the two metal rings (the signal-receiving electrode 62 and noise-sensing electrode 72) to avoid possible short-circuiting or signal attenuation. In one embodiment, the insulation member 74 may be in the shape of a cylinder, and the insulation member 74 may be disposed between the signal-emitting electrode 64 and the signal-receiving electrode 62 and between the signal-emitting electrode 64 and the noise-sensing electrode 72 to insulate the signal-receiving electrode 62, the signal-emitting electrode 64 and the noise-sensing electrode 72 from one another. In this embodiment, a conductive rubber 76 may surround the antenna structure 64a of the signal-emitting electrode 64 to prevent the touch pen 60 from scrubbing a touch panel (not shown). Further, the conductive rubber 76 may have at least one round corner 76a to suit a user's different body postures on using the touch pen 60. According to this embodiment, since the height and surface area of the antenna structure 64a are increased, the diameter of the antenna structure 64a (pen head) is reduced to provide high fineness and comfortability on using the touch pen 60. As shown in FIG. 8, in an alternate embodiment, the signal-receiving electrode 62 and the noise-sensing electrode 72 of a touch pen 70 may be made of a coil of conductive material such as metal.

Note a self-capacitive sensing method and a mutual-capacitive sensing method are both suitable for different embodiments of the invention. Further, sinusoidal waveforms shown in different figures merely exemplify a surface signal and an emission signal, and each of the surface signal and the emission signal may be in other form of a square waveform, a pulse waveform, a triangle waveform, an oblique waveform, and so forth. Besides, a magnification of a reversely amplified signal of the inverted amplifying circuit may be, but not limited to, 50-500, and the magnification can be selected according to the structure of a capacitive touch-sensitive device, the type of a driver IC, the structure of a touch pen, and so forth.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims. Each of the terms “first” and “second” is only a nomenclature used to modify its corresponding element. These terms are not used to set up the upper limit or lower limit of the number of elements.

What is claimed is:

1. A touch pen, comprising:
a power supply circuit for providing the touch pen with a working voltage;
a signal-receiving electrode for receiving at least one surface signal of a touch-sensing electrode structure of a capacitive touch-sensitive device;
a noise-sensing electrode for receiving at least one ambient noise signal;
an inverted amplifying circuit for reversely amplifying a difference between the surface signal and the ambient noise signal to generate a reversely amplified signal; and
a signal-emitting electrode for emitting the reversely amplified signal to attenuate a detection signal of the capacitive touch-sensitive device in a position coinciding with a touch point of the touch pen.

2. The touch pen as claimed in claim 1, wherein a magnification of the inverted amplifying circuit is 50-500.

3. The touch pen as claimed in claim 1, further comprising:
an insulation member disposed between the signal-emitting electrode and the signal-receiving electrode and between the signal-emitting electrode and the noise-sensing electrode to insulate the signal-receiving electrode, the signal-emitting electrode and the noise-sensing electrode from one another.

4. The touch pen as claimed in claim 3, wherein the insulation member is in the shape of a cylinder.

5. The touch pen as claimed in claim 1, wherein the signal-receiving electrode is a metal ring or a coil of metal.

6. The touch pen as claimed in claim 1, wherein the noise-sensing electrode is a metal ring or a coil of metal.

7. The touch pen as claimed in claim 1, further comprising:
a conductive rubber, wherein the signal-emitting electrode comprises an antenna structure and an electrode wire, and the conductive rubber surrounds the antenna structure.

8. The touch pen as claimed in claim 7, wherein the conductive rubber has at least one round corner.

9. The touch pen as claimed in claim 1, wherein the touch-sensing electrode structure comprises a plurality of first sensing series and a plurality of second sensing series, the first sensing series receive at least one scan signal, and the second sensing series receive the detection signal.

10. The touch pen as claimed in claim 1, wherein the inverted amplifying circuit comprises an operational amplifier.

11. The touch pen as claimed in claim 10, wherein the inverted amplifying circuit has positive input, a negative input and an output, the positive input is connected to the noise-sensing electrode, the negative input is connected to the signal-receiving electrode, and the output is connected to the signal-emitting electrode.

12. The touch pen as claimed in claim 11, wherein an output value of the inverted amplifying circuit is obtained by subtracting an input value of the negative input from an input value of the positive input and then multiplying a gain of the operational amplifier.
